(19) United States
(12) Patent Application Publication
(10) Pub. No.: US 2024/0303509 A1
(43) Pub. Date: Sep. 12, 2024

(54) Systems and Methods for Player and Team Modelling and Prediction in Sports and Games

(71) Applicant: Sportlogiq Inc., Montreal (CA)

(72) Inventors: Michael John DAVIS, New Westminster (CA); Juan Camilo GAMBOA HIGUERA, Montreal (CA); Oliver Norbert SCHULTE, Burnaby (CA); Mehrsan JAVAN ROSHTKHARI, Beaconsfield (CA)

(73) Assignee: Sportlogiq Inc., Montreal (CA)

(21) Appl. No.: 18/666,068

(22) Filed: May 16, 2024

Related U.S. Application Data
(63) Continuation of application No. PCT/CA2021/051719, filed on Dec. 2, 2021.

(51) Int. Cl. G06N 5/022; G07F 17/32

(52) U.S. Cl. CPC G06N 5/022; G07F 17/323; G07F 17/3288

(57) ABSTRACT

A system and method are provided for processing game data to generate predictions for hypothetical or real future games. The method includes receiving input data comprising at least one of: i) historical data for one or more previous games, comprising box score information, or ii) play-by-play game data for one or more previous games; and transforming the input data into an abstraction space in which the abstraction space provides an abstraction comprising a numerical representation of player and/or team attributes. The method also includes mapping the numerical representation into one or more predictions of attributes of the games using at least one machine learning technique; and providing output data comprising the one or more predictions of attributes of the games.

This application is a continuation of PCT/CA2021/051719 filed Dec. 2, 2021, the contents of which are incorporated herein by reference in their entirety.

### TECHNICAL FIELD

The following generally relates to systems and methods to be implemented by data analysis systems for player and team performance management, rating, and prediction in sports and games.

### BACKGROUND

The analysis of sports and games data is generally performed to measure player and team performance and to make predictions about the future games. Predictions determine the likelihood of a specific outcome of any game aspect, either at the individual player level or at the team level. Pre-game prediction targets such as game outcomes or the number of goals/points per player/team have become a very important part of fan engagement for sports media and betting/bookmaking in the sports gambling industry.

Predictions of any attribute related to a game or sport, whether individual or team sport, are heavily dependent on properly incorporating as much relevant information as possible about individual players, teams, and the games and model. For example, in a team game sport both individual player performance on different aspects of the game as well as their interactions and collaborative performance as a team should be modeled to make predictions about the upcoming games.

In prior attempts, many methods are found to either focus on predicting the number of points or goals that a player can score, by looking at the historical number of points/goals or focus on predicting a match outcome using simple regression techniques on the box score information without taking into account the game context or individual player skills or team capabilities (e.g., see Buttrey (2016), Marek et al. (2014) and Stanek (2017)).

In other prior attempts, some methods are found to focus on generating win probabilities and chances of scoring the next goal as the game progresses, by looking at the current score differential and looking into the chance of scoring the next goal given the current score differential using rudimentary statistical models (e.g., see Pettigrew (2015)).

Other conventional prior methods are often found to take the number of goals/points a player scored to generate a rating system, and then estimate the expected number of goals/points a player can expect, usually referred to as expected goals.

Some methods have also been developed for evaluating a single event, such as determining the expected value of a player's action by looking at the sequence of the actions that the players took in the same game, for example to measure the chance of a shot to result in a goal in a soccer game. The evaluation of a single event can be used to rank players but is not used to make an explicit prediction about the outcome of the game (e.g., see Schulte et al. (2017) and Liu et al. (2020)).

It is an object of the following to address at least one of the above-noted observations.

### SUMMARY

Described herein is a method of measuring player and team performance in a sport or a game, for predicting future performance of the teams and players and likely outcomes of the games, where the games are either individual or team games. The method can receive relevant information about previous games such as box scores, player actions and game events, player trajectory data, or any combination of those data points. The method can measure both players' and teams' capabilities and skills using different metrics derived from the input data, to generate variables in a latent abstraction space that characterize skills and strengths of the players and teams and can be used in a ranking system to compare players.

Using artificial intelligence and machine learning techniques, the performance of the players and teams can be estimated for future games based on the previously observed information. The outcome of the games can be predicted given the past players performance and their associated metrics and rankings in the abstraction space.

In one aspect, there is provided a method for processing game data to generate predictions for hypothetical or real future games, the method comprising: receiving input data comprising at least one of: i) historical data for one or more previous games, comprising box score information, or ii) play-by-play game data for one or more previous games; transforming the input data into an abstraction space in which the abstraction space provides an abstraction comprising a numerical representation of player and/or team attributes; mapping the numerical representation into one or more predictions of attributes of the games using at least one machine learning technique; and providing output data comprising the one or more predictions of attributes of the games.

In an implementation, the method can further include generating the numerical representation of the player and/or team attributes using a rating system, applied to extended box score information or play-by-play game data.

In an implementation, the method can further include generating the numerical representation of the player and/or team attributes using function approximation techniques, wherein the numerical representation converts the input data to an approximation of the future performance of the players and/or teams.

In an implementation, the abstraction space can represent estimated values of at least summary statistics of box score information or play-by-play game data for hypothetical or real future games.

In an implementation, the method can further include using artificial intelligence and machine learning techniques to learn a mapping function from the historical data.

In an implementation, the method can further include using a function approximator that maps the input data into predictions, by combining both predictive models and the transforming of the input data into the abstraction space in a single function approximator that is learned from the historical data using at least one machine learning technique.

In an implementation, the method can further include generating predictive data for a team roster or lineup and measuring the contribution of each player on at least one attribute of the game to rank and assess a player skill and strength. The at least one attribute can include a game outcome.

In an implementation, the method can further include using the numerical representation of the players to measure player similarity in terms of skills and strengths to be used for coaching and player scouting.

In an implementation, the method can further include generating predictive data for a team roster or lineup and simulating trades and player replacements and their impacts any attributes of the games.

In an implementation, the predictions can be generated for the games while the game is in play, using all the observed historical data up to the moment of the predictions.

In an implementation, the method can further include generating the output data in real-time for sports betting and/or media applications.

In an implementation, the method can further include generating predictive data to detect the possibility of anomalous behavior. The anomalous behavior can include one or more of undiagnosed player injury, match fixing behavior in the players or game officials, or newly emergent team strategies or equipment effects.

In an implementation, the at least one attribute of interest of the game can include one or more of a winning team, a number of goals, or a number of points.

In other aspects, a computer readable medium and device configured to perform the method are provided.

### BRIEF DESCRIPTION OF THE DRAWINGS

Embodiments will now be described with reference to the appended drawings wherein:

FIG. 1 depicts a schematic block diagram of a module or device for player and team modelling for prediction.

FIG. 2 depicts a schematic block diagram of a module or device for player and team modelling for prediction for team games or individual games.

FIG. 3 depicts a schematic block diagram of a module or device for generating predictions from player and team representation in an abstraction space.

FIG. 4A depicts a schematic diagram illustrating a component of the predictions system of FIG. 1 to characterize players and/or teams in terms of their skills and strengths in an abstraction space by using a rating system.

FIG. 4B depicts a schematic diagram illustrating the components of the system of FIG. 4A for an ice-hockey game.

FIG. 4C depicts a schematic diagram illustrating using a function approximation technique to map the historical players'/teams' data into their future performance to form the player/team abstraction for prediction.

### DETAILED DESCRIPTION

In contrast to models and techniques that look at the current score differential and look into the chance of scoring the next goal given the current score differential using rudimentary statistical models, the methods described herein make predictions about one or all attributes of a game that happen in the future, without using the information from that same game.

Moreover, in contrast to estimating expected goals, the disclosed method can use all actions that players are taking in a sports game, as well as the strengths of the teammates and opponents to develop performance metrics indicating the future performance of the players to estimate any attribute of a game, such as the game outcome.

Furthermore, in contrast to prior attempts at sport and game predictive analytics, the following discloses a method for predicting different attributes related to a game, especially event totals such as number of points/goals scored by a player, number of points/goals for each team, number of passes expected from a team, the chance of the game to go to overtime, match outcome, etc. The method incorporates both player- and team-level information characterizing a team and the context of the game that simultaneously measures and predicts players' performances according to a set of predefined metrics and makes predictions for different attributes of an upcoming game. Player-level information metrics are derived from a player's individual actions, while the team-level features are extracted at the team level to incorporate information about the game contexts and how effectively players in a team sport collaborate.

In contrast to prior attempts, in one of the embodiments a method is disclosed in which relevant information about a match or game is incorporated into the models to predict a specific attribute for the match or game. One or more techniques disclosed herein generally support a method and system to predict the outcome of a sports match or game that happen in the future, based on the previously observed games and available historical data.

In an exemplary embodiment, ice hockey is used to describe the details of the disclosed methods, however the same techniques can be used to build predictive models for individual sports and any other team sport, with some minor adjustments to account for different types of data that is available in each sport.

In one embodiment, only the team-level information is considered, which results in modelling a team's skills and strengths as a whole without looking at the individual players to make predictions about different attributes of the future games. In another embodiment, only the player level information is used to model players skills and strengths and then combine that information to predict different attributes of the future games both at the team level and individual player level. In yet another embodiment, both player and team information are used to make the predictions.

An exemplary embodiment of the presently described systems and methods takes historical information about the players and games as the input, and outputs a model of individual and team specific skills that define performance metrics; wherein the performance metrics characterize each player, each team, or both. Those metrics are then ingested by an artificial intelligence or machine learning technique to predict an attribute of interest for a future game such as the game outcome and number of goals scored for each team or each player, based on the teams that are playing against each other and/or the players that are forming those teams.

In this exemplary embodiment, a set of historical data is provided, referred to as the training data set in which there is information about teams and/or individual players that have played against each other in the past.

One or more techniques described herein may use any form of available historical data about the players and games to make the predictions. The available data can include historical game outcome, including game results for the historical games for each team or each player, as well as the information about the team lineup/roster for each game in the past. Additional information can be used to make predictions, such as historical summary covariates, which often include information about player/team action and events, taken over all the previous games. Moreover, the use of contextual covariates such as box scores, extended box scores, and play by play data both at the team level and player level to make predictions is described herein. For each of these data points, contextual information can be incorporated such as the time of the season when the game has happened, the number of days that a team has been resting between the matches, the team lineup and roster information, regular season games versus playoffs, whether a team is playing at home, etc.

Extended box scores and play by play data in sport or games often include a sequence of actions with optional attributes and outcomes. Play by play data corresponds to a plurality of events across a predefined time window, usually a match or a game, and comprises a sparse set of observations, describing the key actions and events that each player or team is taking at every moment in a game. Actions, events, activities, group activities, and interactions which are used interchangeably in the sport analytics prior art refer to players and team actions and interactions with each other and the playing objects such as ball or puck. Some examples are faceoffs, scoring a goal, taking a shot, making a pass, gaining possession of the ball/puck, etc. Actions and activities are characterized by their labels and associated attributes, including but not limited to their outcome, the player or the team that is taking the action, location of that action in space, and the time that an action happens.

The extended box scores and play by play data are available for the historical games but are unknown for the upcoming games that are of interest for prediction. In one embodiment, one or more techniques described herein incorporate the historical extended box scores and play by play data to generate player and team ratings and then use the ratings to make predictions about the future games. In another embodiment, the same extended box score information and play by play data are used to directly make predictions about the next games, without developing a player and team rating system.

Predictions for the future games can span a wide range of attributes of a game. For example, the prediction objective can be predicting the winner of the game, estimating the probability of the game to go to overtime, predicting the scores for each team or player, predicting any attribute related to the extended box score or play by play data such as the number of shots that a player will make, the number of successful faceoffs, the proportion of shots that are blocked, or any other relevant attribute of a game that can be measured. One or more techniques described herein can be trained to generate predictions about one attribute or several attributes of a game, by changing the objective function of the machine learning technique in the training process.

The one or more techniques described herein uses the historical available information about individual players and teams in the team games as the inputs and transfers the input data into an abstraction space. Variables in the abstraction space represent attributes, metrics or ratings characterizing players skills and strengths, as well as the team skills and strengths formed by the players. Those variables are then used to make predictions about different attributes of the hypothetical or real future games. In one embodiment, the abstraction space is a rating system that characterizes teams and players. In another embodiment, the abstraction space is the same as the input space, however the variables in the abstraction space include the extended box score and aggregated or detailed play by play data points for the future games, built for either individual players or a team of players. Those variables are then used to generate predictions about different attributes of the hypothetical or real future games. In yet another embodiment, the abstraction space is an internal representation of the input data generated by a general function approximation technique that maps the input data directly into the predictions for different attributes of the hypothetical or real future games. The abstraction space herein can be either built as a rating system or be learnt from the historical data using general function approximation techniques known in machine learning using a prediction objective for a given task (e.g., match outcome prediction).

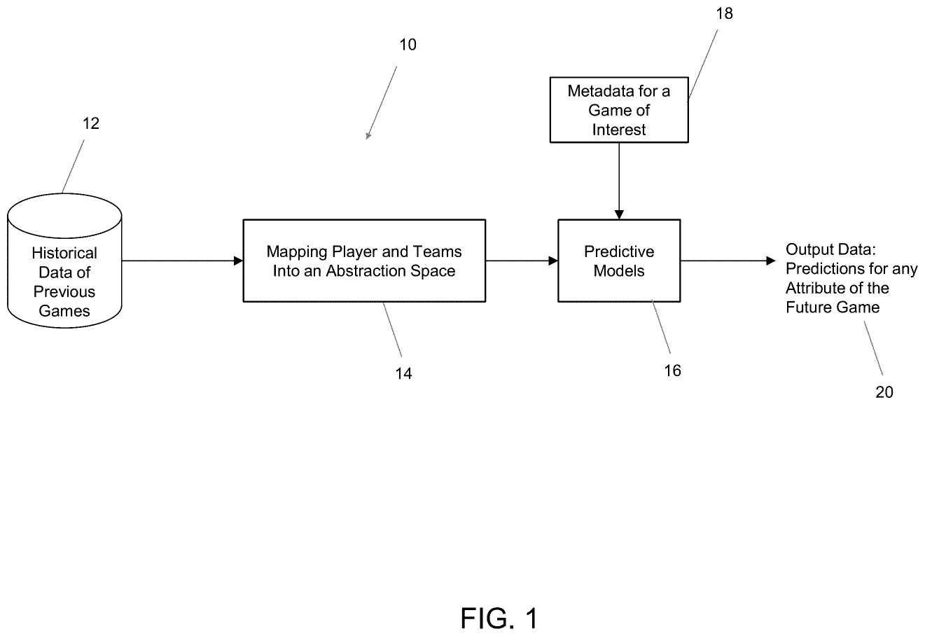

Turning now to the figures, FIG. 1 depicts a schematic block diagram of a module, device or other computing system or component of a computer or computing system 10, for making predictions about a hypothetical or real sport or game that will happen between know teams or players in the future, from historical data 12. Historical data 12 in this example is stored or otherwise made available from a database containing information about the past games between players and teams, and includes at least the outcome of the game, and at least one type of extended box score information, or player and game events or actions. A more comprehensive database of historical data 12 may include all or a subset of information regarding each game, such as actions that players took in the game and the outcome of those actions, or it may include play by play information and player trajectory data. One or more mapping functions 14, hand-crafted or learnt from historical data, transfers the historical information into an abstraction space, wherein each player and/or team is characterized by some variables describing their skills and strengths, in comparison to the other players. One or more predictive models 16 learnt from historical data takes the player and team representations in the abstract space, and generates predictive output data 20 for a game, that is described by provided metadata 18. The metadata indicates the teams and players who will participate in a game, and other relevant aspects of the game, such as which team may play at home. Metadata can be obtained or generated from real games that will happen in the future, or can be generated for any hypothetical game. The outputs 20 include predictions for any attribute of the game, including but not limited to game outcome, score or point for each player and/or team. Output predictions will be used in downstream applications by different users, such as placing bets, setting the odds by a sport bookmaker, or be consumed by sport media broadcasters.

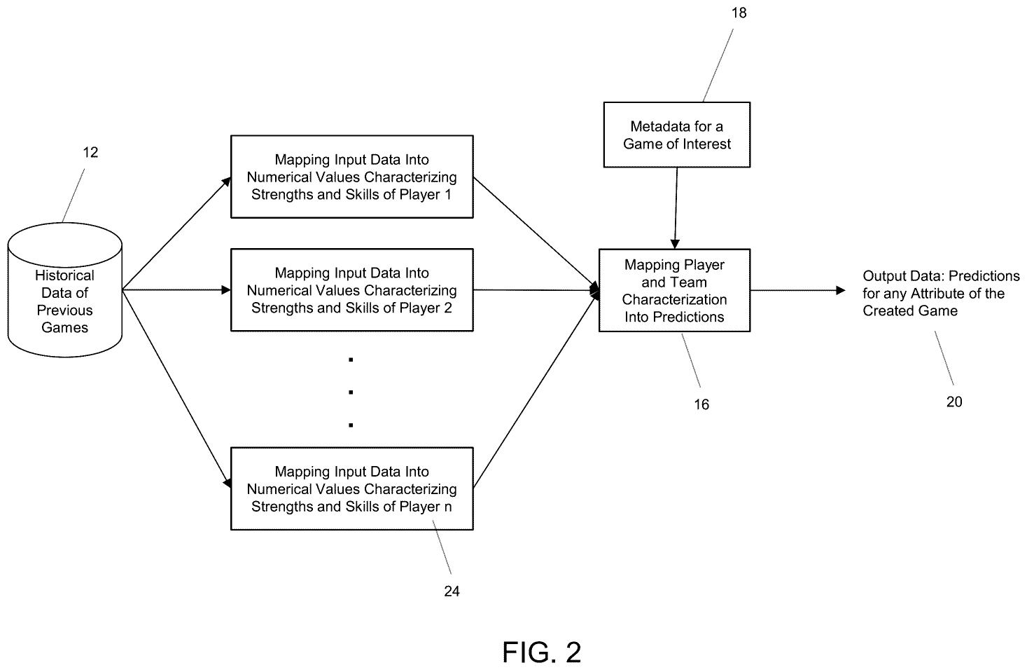

FIG. 2 depicts a schematic block diagram of the process of predicting an attribute of a hypothetical or real game characterized by its metadata 18, which is a team game, by generating numerical values representing attributes such as strengths and skills of the players in the abstractions space 24 using historical data 12, and then using a mapping function 16 that transfers the player representation in the abstraction space 24 into the output data 20, which may include predictions of different attributes of the game. Player and team abstractions 24 can be represented in different forms, such as player and team ratings on different metrics and game data based on historical performance, predicted player and team ratings for the future games, the estimated player/team performance in terms of some type of box score information or aggregated or non-aggregated play-by-play data in the future games, or a learned abstraction from the historical data obtained by using machine learning techniques.

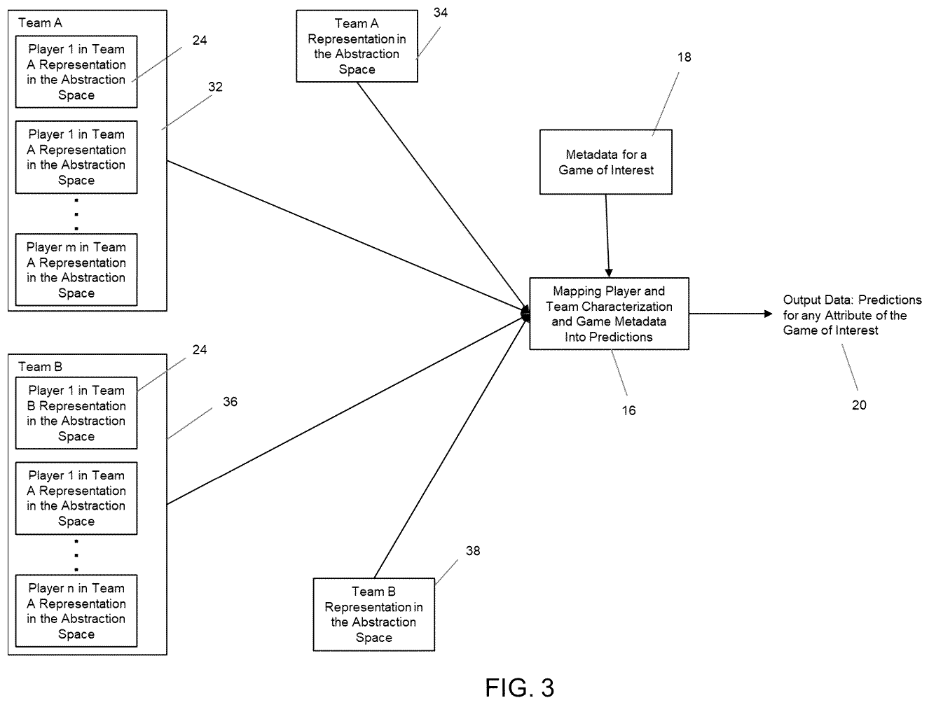

FIG. 3 depicts a schematic block diagram of the process of making predictions about any attribute of a game of interest, whether a team game or an individual game. For a team game, given metadata of a future game or a hypothetical game of interest 18, a team can be formed by using player representations of the players forming that team in the abstraction space 24, combined together as a team 32, 36. Another representation of a team in the abstraction space can be formed by excluding individual players and treating the team as a single unit 34, 38. Team abstraction is similar to player abstraction in nature, but there is no explicit individual representation of the players in there. Metadata for the game of interest 18 provides additional information about the game, for example the time of the game, the location, which team will play home, if the game is in regular season, number of days that a team has rested between games, local weather and climate, recent coaching changes, non-transitive factors like strategy, game officials, relegations and promotions, and any type of information that can be considered as game context and is independent of the player information. The mapping of the game metadata and player and team representations into predictions is carried out by a function approximation technique 16, learned from the historical data 12.

To generate predictions for a team game, at least one of i) abstractions 34, 38 for team A and team B or ii) individual player abstractions and team formation 32 and 36 are required. The two can be combined to make more accurate predictions. For an individual game, the notion of the team can be omitted and only player abstractions are required to make predictions.

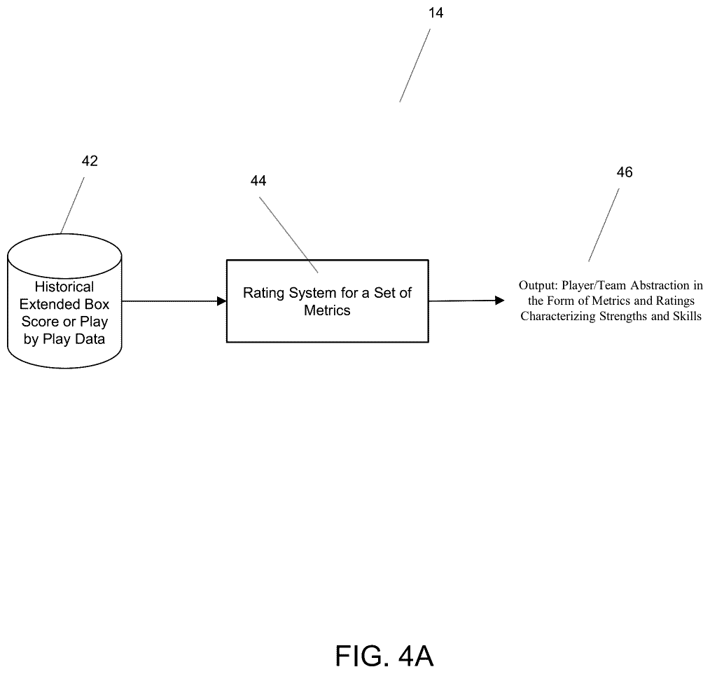

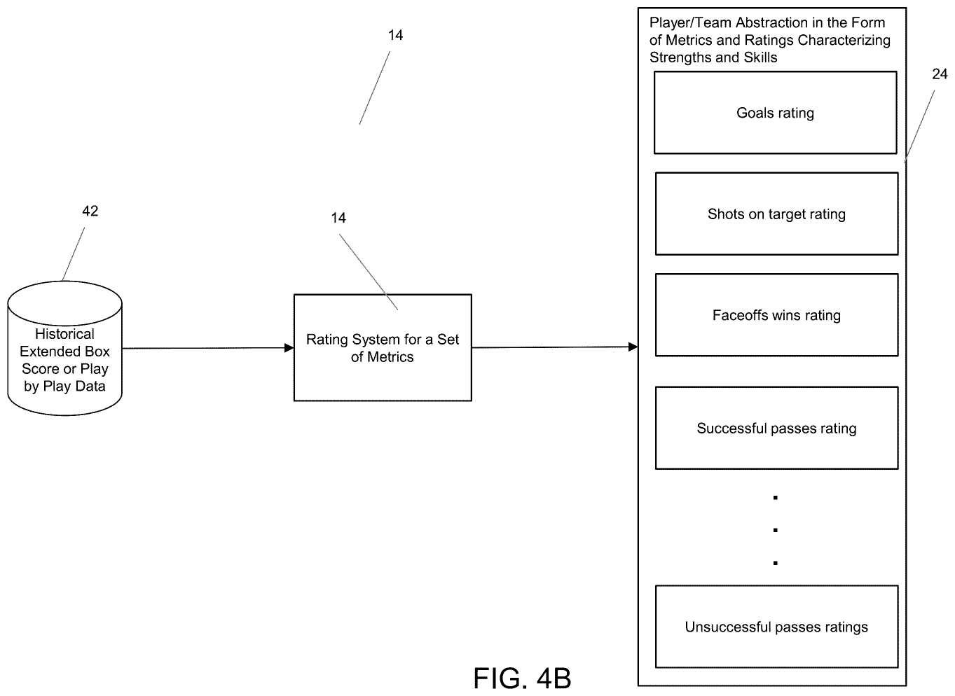

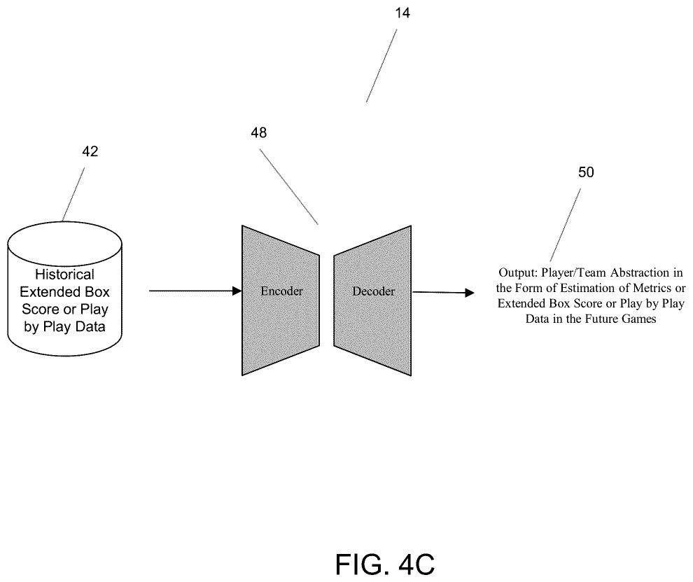

FIG. 4A illustrates a schematic block diagram of an exemplary embodiment for the process of generating an abstract representation of the players and teams and mapping the input historical data 12 in terms of extended box scores or play by play data 42 into numerical representations for players and teams 14. The input data 42 is transformed into metrics or events during the game and a rating system 44 translates the input data into players and teams skills and strengths for every metric related to the input data. Each player or a team is characterized by a set of ratings 46 characterizing the players and/or teams in the abstraction space. The abstract representation of the players and/or teams are used to generate predictions.

FIG. 4B illustrates another representation of an exemplary embodiment for the process illustrated in FIG. 4A for an ice-hockey game. In this example, the player/team abstraction 24 includes, by way of example and not limiting in number or type: goals rating, shots on target rating, faceoff wins rating, successful passes rating, and unsuccessful passes rating, etc.

Similarly, FIG. 4C illustrates a schematic block diagram of an exemplary embodiment for the process of generating an abstract representation of the players and teams and mapping the input historical data in terms of extended box score or play by play data 42 into numerical representations for players and teams 14. Player and team abstractions are generated by using general function approximation techniques, such as deep neural networks in the form of encoder-decoder structures 48 or autoencoder structures in an exemplary embodiment to map the input data into the desired output space 50. The output is player and/or team abstraction in the form of estimation metrics or extended box score or play by play data for the future games, either aggregated or not aggregated. The abstraction system 48 is learned using machine learning techniques from historical data.

In an exemplary embodiment, the abstraction achieved by using a rating system, Glicko ratings are utilized to characterize each player and team on each extended box score and play by play covariates. While the exemplary embodiment focuses on ice hockey as a target application and certain details are related to ice hockey, for those skilled in the art it will be appreciated that the same methods and systems can be used in any individual or team sport. Other rating systems can be used instead of Glicko system, for example the extended box scores and play by play data can be fed into a function approximation models such as artificial neural networks to generate a player or team rating system. In addition, the impact values of each player's actions derived from other game modelling systems can be used instead of the Glicko rating system.

A separate rating can be computed for each extended box score event and play by play data, both for individual players and teams. As an example, the method computes a shot rating for Team A, and shot rating for Team B. Alternatively, the same shot rating can be calculated for Player X from team A and Player Y from Team B. Similar ratings can be produced for other relevant game events, such as faceoffs, passes, loose puck recoveries, etc. The ratings are computed from all of the available information prior to the game that is of interest for prediction.

One of the key aspects of the methods and techniques described herein is the use of contextual information in generating the ratings and making predictions. For example, the extended box score and play by play data box scores results are contextual in the sense that the scores of one team depend on the opponent. Due to the rating system construction, the difference between two team ratings can be interpreted as a prediction of their expected share of the box score event. For example, the difference in the shot rating between Team A and Team B is an indication predicting each team's percentage of the total shots in the match. In addition, in a rating system the notion of strengths of teammates and opposition shall be preserved, as clearly, beating a strong team is more indicative of strength than beating a weak team. Another aspect of context is timing; recent matches are more indicative of strength than matches from the distant past, which is considered in the rating system.

In contrast to prior attempts, the herein described techniques for prediction are interpretable, meaning that the importance of each metric that is used in prediction is clearly measurable and comparable to other metrics, and hence, one can measure the strength of a team for particular types of metrics or game events relative to its opponents. For example, a team's faceoff rating represents how good it is at winning faceoffs. When a metric or a rating covariate is included in the prediction system, the corresponding fitted parameter allows the user to interpret the extent to which the metrics and ratings affects winning. Therefore, the metrics and ratings used in predictions will be valuable for the coaches, players, fans, and other stakeholders, even outside the primary target application for game prediction.

The methods and systems described herein can generate a predictive analysis about any game—as they are using player level metrics and features to make predictions any hypothetical scenario can be evaluated, for example one can simulate a trade of a player X for player Y in Team A and generate predictions for a game between Team A and B.

Although the exemplary embodiment uses information from the past games to make predictions for future games, the methods can be extended for in-game prediction. A simple extension will be to update the player and team metrics and rating with all the observations up to the current moment in a game, and then make predictions for any attribute of the same game for the future moments up to the end of the game.

The one or more techniques described herein models individual players in terms of their skills and capabilities based on the measurements derived from box scores or play by play data of the games. Given a team roster and the calculated metrics for a team based on historical data, it generates a metric for team skills and capabilities given individual players skills as quantified by the player model. The team skill metrics are used to generate the predictions about the future games. This is in contrast to the prior art techniques where they solely rely on win trends for a team to make predictions for the next game.

An exemplary embodiment of the presently described systems and methods takes information about a sports game, such as ice hockey, to make predictions about some attributes of the future games. Players and teams are described by metrics related to their skills and strengths, and those metrics are then used to make predictions for the next games.

In the exemplary embodiment, the extended box score and play by play data for an ice hockey game includes a set of different player/team actions and game events, including but not limited to goals scored, overtime goals scored, even-manpower goals scored, shootout goals scored, overtime shots on target, faceoff wins, face off losses, shots on target, shots wide of target, body checks or hits, failed loose puck recoveries, powerplay goals, unsuccessful power plays, controlled offensive zone entries, defensive zone exits, successful defensive zone clearances, unsuccessful defensive zone clearances, successful offensive zone dump-ins, unsuccessful offensive zone dump-ins, successful passes, unsuccessful passes, successful puck protections, unsuccessful puck protections, opponents shots blocked, opponents passes blocked, opponents shots pressured, penalties suffered, penalties drawn.

To transfer the input play by play data or extended box score information to an abstract space that maps the input data to attributes that describe teams and players skills and strengths to make them usable for prediction, different methods and techniques are disclosed herein.

To map the play by play data or box score into the abstract space that represents players or teams strengths and impacts, rating systems can be used on each box score or action/event type. As an example, the Glicko algorithm can be used to generate ratings per event/action type based on the historical data. In essence, every action that a player takes or an event for a team produces a micro victory or defeat for that player or team depending on the outcomes, a micro victory or defeat for that opponent. Each player or team is assigned a rating for each of these events and actions based on their outcomes.

As an example, prior to a game, a team or a player has a Glicko rating r and a Glicko rating deviation RD for each extended box score and play by play event type. These dynamic parameters represent team strength and variability, corresponding to the extended box score event type. Denote the opponent's parameters by rₒ and RDₒ, respectively. At the beginning of data collection, teams are assigned starting values such as r=1500 and RD=350.

After the game, an extended box score outcome pϵ(0,1) is obtained which characterizes the proportion of the event realized by the team or player of interest.

The introduction of p is an extension to Glicko where Glicko outcomes in a paired comparisons setting are restricted to 1, ½ and 0 corresponding to a win, loss, and draw, respectively. More sophisticated uses of margins of victory can be also used. With the box score outcome p observed for a particular event, the team's or player's Glicko parameters are updated for the pair of teams or players as follows:

$${r}^{′} = r + \frac{ln ( 10 ) / 400}{\frac{1}{{RD}^{2}} + \frac{1}{{d}^{2}}} g ( {RD}_{o} ) ( p - E ( p ) )$$

$${RD}^{′} = {( \frac{1}{{RD}^{2 + \frac{1}{{d}^{2}}}} )}^{- \frac{1}{2}}$$

$$where , g ( RD ) = {( 1 + \frac{3 {( RD ln ( 10 ) )}^{2}}{{( 400 π )}^{2}} )}^{- \frac{1}{2}}$$

$$E ( p ) = {( 1 + {10}^{- \frac{g ( {RD}_{o} ) ( r - {r}_{o} )}{400}} )}^{- 1}$$

$$\frac{1}{{d}^{2}} = {( g ( {RD}_{o} ) ln ( 10 ) / 400 )}^{2} E ( p ) ( 1 - E ( p ) )$$

In this rating, greater variability (i.e., larger RD) occurs when teams or players have played fewer games and or when all games are played in the distant past. This is important for prediction applications since team compositions tend to change during the off-season due to player trades and the draft. Values of RD at the beginning of a season should be larger than during mid-season. Entering into a game, each team or player will have Glicko ratings r₁, r₂, . . . , rₖ and Glicko rating deviations RD₁, RD₂, . . . , RDₖ corresponding to the k box score events. These ratings are updated after new observations for box score and play by play events.

Player or team abstraction can be seen as a mapping function, T, that maps the input data/into the desired output space O, by applying some mathematical operations: O=T(I). In one exemplary embodiment, T is a rating system applied on the extended box score information or play by play data, and each player or team is then represented by a numerical characterization aggregated representation for the players or the team as a single unit, in a multidimensional space. In case of using the above ratings, each player can be represented by a multidimensional vector OϵR^{k}.

Ratings that are generated for players and teams based on the box score data or play by play information measure the skills and strengths of the players and their impact in a game to reach a certain objective. Using those, a player or a team is characterized by some numerical values representing relevant skills and strengths measured in comparison to other players and teams. This form of characterization is seen as transforming the input data into an abstract space, in which each player and a team is characterized by a set of metrics relevant to the game.

Player and team ratings on game attributes are a form of player abstraction, wherein the players are being represented by numerical values mapping the numerical or ordinal input variables into a numerical presentation characterizing the players and teams.

Alternatively, instead of generating ratings and player and team strength models, using historical data, function approximation techniques such as time series models or artificial neural networks can be used to create the abstraction space. As an example, using a proper objective function and historical data, the extended box score and play by play information can be mapped into an abstraction space, in which the variables that are characterizing each player or team are aggregated play by play information or box scores for the future games. In this case, T is a mapping function learned from historical data, and maps the historical extended box score and play by play data for each player and/or team from the past n data points up to the current moment t, I={Iₜ₋ₙ, . . . , Iₜ₋₁, Iₜ}, into an abstraction that represents the future extended box score or play by play data for the player and/or team, O=T({Iₜ₋ₙ, . . . , Iₜ₋₁, Iₜ}). For direct estimation of future box score or play by play data, O=I′ₜ₊₁, where I′ₜ₊₁ is the estimated future data for extended box score or play by play data. Instead of estimating all the extended box score or play by play data, the estimated output can be a form of aggregated data for a player or team, such as the normalized total number of shots, passes, etc.

The numerical mapping function, T, can be learned from historical data, sometimes referred to as training data. T can be a multi-task trained function that generates all the desired outputs or can be a set of distinct mapping functions where each one is trained to generate a subset of the desired outputs. Assuming that T uses function approximation techniques such as artificial neural networks, the parameters of all the components of T could be either estimated separately or jointly using standard machine learning techniques such as gradient based learning methods that are commonly used for artificial neural networks. In one ideal setting, the whole parameter estimation of those components can be estimated using a standard loss function, learnt from a set of available labelled examples. To learn the abstract representation of the players, one can define a loss function, L, such as cross entropy or regression loss or any define loss function that measures the difference between the predicted output, I′ₜ and the real data, Iₜ for a subset of training data: Tϵarg min L(I′ₜ, Iₜ).

Once the play by play information and box score data is mapped into an abstraction space with variables characterizing players and teams strengths, those variables, such as player and team rating on different metrics are then fed into a predictive model that generates predictions for different attributes of a hypothetical or real future game. The predictive model can be a regression model, or a nonlinear function approximation technique such as artificial neural networks that uses the historical data to learn a combination of the variables in the abstraction space to generate predictions. Assuming the predictive model is a function approximator, such as a regression model or a neural network, F, it takes the representations of each team/player in the abstractions spaces to generate predictions. For simplicity, team A and team B are represented by O_{A} and O_{B} in the abstraction space, and the predictive attribute, such as game outcome, p=F(O_{A}, O_{B}).

The numerical mapping function, F, can be learned from historical data, sometimes referred to as training data. Assuming that F uses function approximation techniques such as artificial neural networks, the parameters of all the components of F could be estimated using standard machine learning techniques such as gradient based learning methods that are commonly used for artificial neural networks. One can define a loss function such as cross entropy loss that measures the difference between the predicted output, p, and the real data, p_{gt}, for a subset of training data: Fϵarg min L(p, p_{gt}). F can be either one mapping function that predicts all or a subset of attributes of a game of interest or can be a set of mapping functions that each mapping function is specifically designed to predict one attribute of the game. To predict all the attributes of the games, a loss function can be defined as a weighted sum of individual loss functions on each attribute of the game:

Loss=Σ_{iϵgame attributes} wᵢLᵢ(p,p_{gt}).

An F is estimated by minimizing the Loss on the training data.

In another embodiment, the abstraction mapping function, T, and the prediction model, F, can be combined together to generate predictions directly from the input data. Assuming that the overall predictive model, G=F (T), then p=G(I). G can be learned the same way F is learned, however the difference is that the input data for those functions are different. In case of using a deep neural network to represent G, the earlier layer in the artificial neural network will represent the abstraction function, T, and the later layers such as the last layer will present the predictive model, F.

Team lineup and roster adjustments can be applied to player impact models and ratings to measure skills and strengths of the players. In team sports, the players that make up a team change between matches. This can happen through long-term changes like trades, drafts, or retirements; or through short-term changes like injuries, loans, or routine roster changes and rotations. Because of player changes, the prediction technique models teams not only as a single unit, but also includes player level skills and strengths. In the disclosed rating system and the mapping that transfers input data into the abstract space to measure player skills and strengths, adjustments are made to effective ratings in response to day-to-day roster changes. Given the past and known future schedules, players and team's historical data as well as recent and long-term performance, and injury information, the players that are playing in the next game are predicted. This is in contrast to the commonly used team ratings which neither include extended box score information nor team roster-adjustments that can account for long-term changes like trades and transfers.

In one exemplary embodiment, a prediction method is disclosed which leverages extended box scores and play by play data in the form of aggregated statistics to generate a representation for the players and teams to map them into an abstraction space and make predictions about different attributes of the game such as outcome prediction. To generate abstract representations of the players and teams, ratings are applied on each one statistically in the extended box score or summary statistics of play by play data. To make predictions, the abstract representations of players and teams in the form of a set of ratings are used as covariates in a logistic regression model. The method provides more accurate predictions than the traditional win/loss prediction methods and outperforms the closing market odds for NHL hockey as an exemplary application for sports betting, generating positive revenue for sports betting.

A similar method can also be used to make predictions about players presence/absence for the future games, and generate more complex predictions about game attributes such as outcome of the game in regular time versus overtime.

In yet another exemplary embodiment, the individual player strengths and impacts can be learnt from historical data using machine learning techniques or by applying statistical models. For example, the player actions/game event ratings can be attributed to a given player, using the information such as the average number of specific events and actions, such as shots, that a team produces per game; the proportion of each given event and action that each player contributes to that team average; and the average proportion that a player contributes to a team. The individual player impacts can be normalized based on other factors, such as the amount of time played for the team in a game. For new or replacement level players, the player impacts can be calculated by pooling the impact of all players of a given position or players with similar playing style, e.g., forward, defence, goaltender, with similar number of games played in the past.

Using team roster-adjusted metrics and impact ratings improves the predictive ability of models compared to unadjusted ratings. It also provides a convenient way to hypothetically change a team lineup or roster and get predictions that adapt to the changes. Since the difference in ratings are predictive of the expected value of a box score or summary statistics, the roster adjustments are a way of increasing, decreasing that box score based on the expected player contributions to make more realistic predictions that reflect player strengths and skills.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

### REFERENCES

Buttrey, S. E. (2016). Beating the betting market on NHL hockey games. Journal of Quantitative Analysis in Sports, 12, 87-98.
Marek, P., Sediva, B. and Toupal, T. (2014). Modeling and predic-tion of ice hockey match results.Journal of Quantitative Analysis inSports, 10, 357-365.
Stanek, R. (2017). Home bias in sport betting: Evidence from Czechbetting market. Judgment and Decision Making, 12, 168-172.
Pettigrew, S. (2015). Assessing the offensive productivity of NHL players using in-game win probabilities. In 9th annual MIT sloan sports analytics conference (Vol. 2, No. 3, p. 8).
Schulte et al. (2017), System and Method for Evaluating Team Game Activities, PCT/CA2017/050253.
Liu, Guiliang, Oliver Schulte, Pascal Poupart, Mike Rudd, and Mehrsan Javan. “Learning Agent Representations for Ice Hockey.” Advances in Neural Information Processing Systems 33 (2020).

1. A method for processing game data to generate predictions for hypothetical or real future games, the method comprising:
receiving input data comprising at least one of: i) historical data for one or more previous games, comprising box score information, or ii) play-by-play game data for one or more previous games;
transforming the input data into an abstraction space in which the abstraction space provides an abstraction comprising a numerical representation of player and/or team attributes;
mapping the numerical representation into one or more predictions of attributes of the games using at least one machine learning technique; and
providing output data comprising the one or more predictions of attributes of the games.

2. The method of claim 1, further comprising generating the numerical representation of the player and/or team attributes using a rating system, applied to extended box score information or play-by-play game data.

3. The method of claim 1, further comprising generating the numerical representation of the player and/or team attributes using function approximation techniques, wherein the numerical representation converts the input data to an approximation of the future performance of the players and/or teams.

4. The method of claim 1, wherein the abstraction space represents estimated values of at least summary statistics of box score information or play-by-play game data for hypothetical or real future games.

5. The method of claim 3, further comprising using artificial intelligence and machine learning techniques to learn a mapping function from the historical data.

6. The method of claim 1, further comprising using a function approximator that maps the input data into predictions, by combining both predictive models and the transforming of the input data into the abstraction space in a single function approximator that is learned from the historical data using at least one machine learning technique.

7. The method of claim 1, further comprising generating predictive data for a team roster or lineup and measuring the contribution of each player on at least one attribute of the game to rank and assess a player skill and strength.

8. The method of claim 7, wherein the at least one attribute comprises a game outcome.

9. The method of claim 1, further comprising using the numerical representation of the players to measure player similarity in terms of skills and strengths to be used for coaching and player scouting.

10. The method of claim 1, further comprising generating predictive data for a team roster or lineup and simulating trades and player replacements and their impacts any attributes of the games.

11. The method of claim 1, wherein the predictions are generated for the games while the game is in play, using all the observed historical data up to the moment of the predictions.

12. The method of the claim 1, further comprising generating the output data in real-time for sports betting and/or media applications.

13. The method of the claim 1, further comprising generating predictive data to detect the possibility of anomalous behavior.

14. The method of claim 13, wherein the anomalous behavior comprises one or more of undiagnosed player injury, match fixing behavior in the players or game officials, or newly emergent team strategies or equipment effects.

15. The method of claim 1, wherein the at least one attribute of interest of the game comprises one or more of a winning team, a number of goals, or a number of points.

16. A non-transitory computer readable medium storing computer executable instructions for processing game data to generate predictions for hypothetical or real future games, comprising instructions for:
receiving input data comprising at least one of: i) historical data for one or more previous games, comprising box score information, or ii) play-by-play game data for one or more previous games;
transforming the input data into an abstraction space in which the abstraction space provides an abstraction comprising a numerical representation of player and/or team attributes;
mapping the numerical representation into one or more predictions of attributes of the games using at least one machine learning technique; and
providing output data comprising the one or more predictions of attributes of the games.

17. A computing device for processing game data to generate predictions for hypothetical or real future games, comprising:
a processor; and
memory, the memory comprising computer executable instructions that when executed by the processor cause the computing device to:
receive input data comprising at least one of: i) historical data for one or more previous games, comprising box score information, or ii) play-by-play game data for one or more previous games;
transform the input data into an abstraction space in which the abstraction space provides an abstraction comprising a numerical representation of player and/or team attributes;
map the numerical representation into one or more predictions of attributes of the games using at least one machine learning technique; and
provide output data comprising the one or more predictions of attributes of the games.

18. The computing device of claim 17, further comprising instructions for generating the numerical representation of the player and/or team attributes using a rating system, applied to extended box score information or play-by-play game data.

19. The computing device of claim 17, further comprising instructions for generating the numerical representation of the player and/or team attributes using function approximation techniques, wherein the numerical representation converts the input data to an approximation of the future performance of the players and/or teams.

20. The computing device of claim 17, wherein the abstraction space represents estimated values of at least summary statistics of box score information or play-by-play game data for hypothetical or real future games.
